(19) United States
(12) Patent Application Publication
(10) Pub. No.: US 2025/0299436 A1
(43) Pub. Date: Sep. 25, 2025

(54) OPTICAL EFFECT SYSTEM FOR ATTRACTION SYSTEM

(71) Applicant: Universal City Studios LLC, Universal City, CA (US)

(72) Inventor: Akiva Meir Krauthamer, Orlando, FL (US)

(21) Appl. No.: 18/612,781

(22) Filed: Mar. 21, 2024

(51) Int. Cl. G06T 15/60; A63J 21/00; G06T 7/70

(52) U.S. Cl. CPC G06T 15/60; A63J 21/00; G06T 7/70; G06T 2207/30196; G06T 2215/12

(57) ABSTRACT

An optical effect system of an amusement park that utilizes a Pepper's Ghost-based effect to provide a more realistic portrayal of a virtual shadow by combining visual elements of a primary area and visual elements of a secondary area. In particular, the optical effect system detects one or more characteristics of an interactive element, such as a person or object, within the primary area via a sensor. The one or more characteristics may include position, orientation, outline, movement, or the like of the interactive element. Further, the optical effect system generates and/or adjusts image data comprising a virtual shadow based on the detected one or more characteristics. The optical effect system additionally causes display of the image data within the secondary area, such that imagery of the virtual shadow is reflected by a beam splitter and combined with imagery of the interactive element within the primary area.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Throughout amusement parks and other entertainment venues, special effects (e.g., optical effects) can be used to help immerse guests in the experience of a ride or attraction. Immersive environments may include three-dimensional (3D) props and set pieces, robotic or mechanical elements, and/or display surfaces that present media. For example, amusement parks may provide an augmented reality (AR) experience for guests. The AR experience may include presenting virtual elements to guests, and the virtual elements may provide unique special effects to the guests. The special effects may enable the amusement park to provide creative methods of entertaining guests, such as by presenting simulated real world elements and an impression of guests interacting with the simulated real world elements in a convincing manner.

For example, traditional amusement park attractions (e.g., show attractions) may utilize various combinations of physical show elements (or props), staging, and lighting to create various visual effects from the guest's perspective. One commonly utilized visual effect may be referred to as a Pepper's Ghost illusion. For example, a traditional Pepper's Ghost system may employ a primary stage (a primary scene), a secondary stage (a secondary scene), and an optical beam splitter (e.g., a pane of glass, a screen) positioned to essentially combine images from each scene when viewed from a guest's point of view. Imagery from the secondary scene may be reflected from the beam splitter (e.g., reflected from a glass surface) toward the guest, while imagery from the primary scene is transmitted through the beam splitter (e.g., transmitted through the glass). Stage lighting may be controlled to illuminate aspects of the scenes but not the beam splitter. This may increase visibility of desired scene features and limit or prevent observation of the beam splitter itself by the guest. This creates an illusion of a physical presence on the primary stage that is actually a mere reflection of the secondary stage.

While well-established effects, such as a traditional Pepper's Ghost effect, are effective illusions, it is now recognized that these traditional effects may lack meaningful and/or realistic guest interaction. For example, a guest located on the primary stage may interact with aspects of the secondary scene reflected from the beam splitter in an unrealistic manner thereby disturbing the visual illusion of the Pepper's Ghost effect. Accordingly, improved amusement park attraction systems providing more realistic and interactive Pepper's Ghost illusions are desired.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, an optical effect system includes a sensor configured to capture sensor data from an optical effect area. A display system is configured to display an image based on the sensor data. A beam splitter is disposed between the optical effect area and an observation area such that the optical effect area is observable through the beam splitter from the observation area. The beam splitter is positioned to reflect light from the image toward the observation area. The optical effect system includes a control system that is configured to determine a characteristic associated with a person or object in the optical effect area from the sensor data, and to determine the image based on the characteristic such that, when the image is displayed by the display system, the image is overlapping with the person or object when viewed from the observation area.

In an embodiment, a method of operating an optical effects system of an attraction system includes receiving, at a processing system, sensor data comprising one or more characteristics of a person or object positioned within an optical effect area. The sensor data is received from a sensor configured to monitor the optical effect area. The method also includes generating, at the processing system, image data based on the sensor data for a display system, wherein the image data comprises a virtual shadow with one or more visual characteristics that correspond to the one or more characteristics of the person or object. The processing system instructing display of the image data, wherein the image data is configured to be reflected and combined with imagery of the optical effect area via a beam splitter.

In an embodiment, an attraction system of an amusement park includes an optical effect system that includes a primary stage configured to accommodate an interactive element, a secondary stage configured to accommodate a display, a sensor configured to detect one or more first characteristics associated with the interactive element, and a control system. The control system includes a processor system configured to receive sensor data from the sensor, wherein the sensor data comprises the one or more first characteristics, generate image data comprising a virtual shadow, wherein the virtual shadow comprises a darkened silhouette of the interactive element with one or more second characteristics that correspond to the one or more first characteristics, and cause display of the image data within the secondary stage. The optical effect system also includes a beam splitter disposed between the primary stage and an observation area, wherein the beam splitter is configured to reflect the display of the image data towards the observation area, and wherein the observation area is positioned to enable a guest of the attraction system to view a combination of the reflected display of the image data and the interactive element.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an attraction system within an amusement park or theme park, in accordance with an aspect of the present disclosure;

FIG. 2 is a schematic overhead view of an embodiment of the attraction system of FIG. 1, in accordance with an aspect of the present disclosure;

FIG. 3 is a perspective view of an embodiment of the attraction system of FIG. 1, in accordance with an aspect of the present disclosure;

FIG. 4 is a flowchart of an embodiment of a method or a process for operating the attraction system of FIG. 1 to provide a realistic virtual shadow effect via the Pepper's Ghost illusion, in accordance with an aspect of the present disclosure; and

FIG. 5 is a flowchart of an embodiment of a method or a process for operating the attraction system of FIG. 1 to provide a realistic virtual shadow effect via the Pepper's Ghost illusion, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value.

The present disclosure relates generally to an attraction system that includes an improved interactive and/or responsive optical effect system for entertainment venues (e.g., theme parks, amusement parks, theaters.) The optical effect system employs an effective and more realistic Pepper's Ghost effect. In particular, the present disclosure relates to an optical effect system that, based on detecting interaction and/or visual information from a guest, adjusts aspects of the Pepper's Ghost effect to increase the realism of a perceived Pepper's Ghost illusion, and thus improves guests' entertainment and immersive experiences within the attraction system.

The optical effect system (e.g., show effect system, visual effect system, optical effect generation system) may be configured to present virtual or simulated elements that supplement real world elements via the Pepper's Ghost effect. Specifically, as further discussed herein, “Pepper's Ghost” may refer to a visual effect enabled by various staging/lighting structures and techniques that may include a primary area (e.g., primary stage, background scene, optical effect area), a secondary area (e.g., secondary stage, augmented reality scene), and an optical beam splitter (e.g., a pane of glass, a screen) positioned to essentially combine images from each area when viewed from a guest's point of view. In particular, the optical beam splitter may be arranged to enable imagery within the primary area to be viewable through and/or transmitted through the optical beam splitter. The optical beam splitter may also reflect imagery of the secondary area. As such, a guest located within an observation area may observe imagery from the primary area (e.g., real imagery transmitted from the primary area through the optical beam splitter) and imagery from the secondary area (e.g., virtual and/or real imagery reflected from the secondary area off of the optical beam splitter) in a combined, superimposed, or overlaid fashion with respect to one another. Stage lighting may be controlled to illuminate aspects of the scenes and enhance the Pepper's Ghost illusion, while improving concealment of the optical beam splitter. This may increase visibility of desired scene features and limit or prevent observation of the optical beam splitter itself by an audience. Thus, the Pepper's Ghost effect may create an illusion of a physical presence of elements (e.g., real and/or virtual elements) on the primary stage that are actually mere reflections of the elements within the secondary stage.

Embodiments of the present disclosure are directed to an improved operation of the optical effect system utilizing the Pepper's Ghost-based technique to provide a more realistic portrayal of combined elements of a secondary area and elements of a primary area. In particular, imagery of the elements of the secondary area (e.g., imagery on a display, projected imagery) may be adjusted or manipulated to portray distortion, alteration, and/or interaction based on interaction of objects and/or individuals (e.g., guests) located within the primary area. As such, the optical effect system may increase the realism with respect to reflective and/or refractive elements (e.g., reflected via the beam splitter) as viewed by other guests within the attraction system (e.g., within the observation area.) In other words, the optical effect system may enable visually persuasive guest interaction with elements (e.g., virtual elements) reflected via the beam splitter. In particular, the optical effect system may detect a position (e.g., location, depth), outline (e.g., silhouette, contour, boundary), and/or movement of interactive elements (e.g., a guest or guests, an object) within (e.g., accommodated within) the primary area of the Pepper's Ghost effect and adjust imagery associated with the secondary area that is reflected by the beam splitter based on the detected position (e.g., location, depth), outline (e.g., silhouette, contour, boundary), and/or movement of interactive elements.

As an example, detected interaction of a guest located within the primary area may cause changes to a scene or enhance a visual effect of the scene as observed by another guest. Specifically, the optical effect system may detect a position (e.g., location, depth), outline (e.g., silhouette), and/or movement of the guest located within the primary area, and generate and/or adjust imagery associated with the secondary area (e.g., imagery reflected to combine with imagery of the primary area) to include a virtual silhouette and/or shadow (e.g., a dynamic darkened silhouette) of the guest that corresponds to (e.g., mimics, correlates) the detected position, outline, and/or movement of the guest. As a result, the beam splitter enables the virtual silhouette and/or shadow from the secondary area to be visually overlaid (e.g., overlapped, visually combined) with the guest and/or any other imagery of the primary area from a point of view of other guests positioned in an observation area of the attraction system.

In this way, the optical effect system may create an enhanced Pepper's Ghost illusion in which the imagery, including the virtual silhouette and/or shadow, associated with the secondary area appears as though it is physically present within the primary area and/or interactive with (e.g., responsive to) physical (e.g., real) elements, such as the guest, within the primary area. In other words, embodiments of the present disclosure may enable a realistic virtual shadow effect to be presented to other guests of the attraction system via the Pepper's Ghost effect. Furthermore, the realistic virtual shadow effect may be dynamic and/or continuously adjusted based on detected position (e.g., location, depth), outline (e.g., silhouette, contour, boundary), and/or movement of the interactive elements (e.g., a guest or guests) within the primary area.

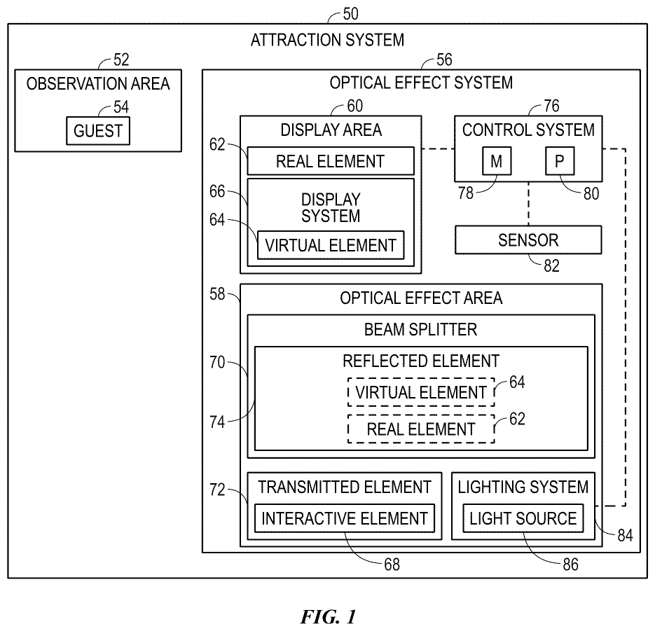

With the preceding in mind, FIG. 1 is a schematic diagram of an embodiment of an attraction system 50 within an amusement park or theme park. The attraction system 50 is illustrated as including an observation area 52 with a guest 54 positioned therein and an optical effect system 56, which is at least partially viewable and potentially accessible from the observation area 52. As an example, the observation area 52 may include a path (e.g., a walkway, a queue, a line) or open space through which the guest(s) 54 may pass. As another example, the observation area 52 may include a space (e.g., a seating area) where the guest(s) 54 may be positioned to view a performance. As a further example, the observation area 52 may include a ride vehicle that may move and carry the guest(s) 54 throughout the attraction system 50.

Furthermore, the attraction system 50 may include the optical effect system 56 (e.g., a Pepper's Ghost-based system, show effect system, optical effect generation system) that may provide entertainment to the guest(s) 54 located in the observation area 52 and/or within the attraction system 50. For example, the optical effect system 56 may create visual effects that are viewable by the guest(s) 54. In an embodiment, the optical effect system 56 may include an optical effect area 58 (e.g., a primary area, a primary stage, a background scene) that the guest(s) 54 may view from the observation area 52. As an example, the optical effect area 58 may include a stage where physical element(s) (e.g., a physical object, a performer, another guest, a prop) may be positioned (e.g., included, accommodated) and/or a display screen where an image may be projected.

The optical effect system 56 may also include a display area 60 (e.g., a secondary area, an augmented reality scene.) The display area 60 may include real element(s) 62 (e.g., a physical object, a performer, a prop, an animated figure), virtual element(s) 64, and/or a combination thereof. The virtual element(s) may include an image as emitted via a display system 66, which may include (e.g., accommodate) a display (e.g., a display screen) and/or projector system (e.g., image projected via a projector onto a screen.)

In particular, the virtual element(s) 64 in the display area 60 may include digitally rendered imagery that is displayed and/or projected within the display area 60 via the display system 66. By way of example, in some embodiments, the display area 60 may include a light field display in which a three-dimensional (3-D) image may be projected, a projector, or other device (e.g., a display, a backlit display, LED display screen(s), LCD display, OLED display) configured to cause display of the virtual element(s) 64. For instance, the display area 60 may include a display array or surface (e.g., an array of lenses) that may manipulate how light converges, focuses, and/or is directed. For example, the display array may cause light to focus at different locations, such as different depths with respect to a point of view of the guests 54. The manipulation of light properties may cause an image projected onto or via the display array to have an appearance of layers, contour, and/or texture, thereby forming 3-D profile for the projected image.

Additionally or alternatively, the display area 60 may include a different display, such as a two-dimensional (2-D) display and/or a 3-D display that does not use a light field display. In such an embodiment, the virtual element(s) 64 may be projected based on a determined view of the guest(s) 54, such as based on an eye location of the guests 54 to present an accurate appearance of reflection of the virtual elements 64 from the perspective of the guest(s) 54. Additionally or alternatively, multiple viewpoints of the virtual element(s) 64 may be presented, time multiplexed images (e.g., synchronized refreshing of images and alternating illumination of the images from different viewpoints) may be utilized, and so forth, to simultaneously provide different perspectives of the virtual element(s) 64 (e.g., to multiple guests 54 positioned at different locations in the observation area 52). In some embodiments, the display area 60 may include a projector or other device (e.g., a display) configured to cause the virtual element(s) 64 to be displayed within the display area 60.

The real element(s) 62 may represent any number of real world objects. As discussed herein, imagery of the real element(s) 62 may be projected towards or onto a beam splitter (e.g., beam splitter 70) and viewed as a reflection of the real element(s) 62 (e.g., reflected element(s) 72) by the guest(s) 54. The reflection of the real elements(s) 62 may overlap the optical effect area 58 (e.g., the interactive element(s) 68), such that the real element(s) 62 appear as though they are physically present (e.g., co-located) within the optical effect area 58. In addition, the optical effect system 56 (e.g., via a control system 76) may adjust an appearance of the virtual element(s) 64 based on the real element(s) 62. By way of example, the optical effect system 56 may adjust the appearance of the virtual element(s) 64 to simulate an interaction between the virtual element(s) 64 and real element(s) 62. Furthermore, as discuss in more detail below, the optical effect system 56 may adjust the appearance of the virtual element(s) 64 to simulate an interaction or cohesion between the reflected virtual element(s) 64 and/or real element(s) 62 and any objects and/or persons (e.g., guests) located in the optical effect area 58. It should be appreciated that in some embodiments, the optical effect system 56 may not include the real element(s) 62 within the display area 60, and thus produce the virtual shadow effect by the virtual element(s) 64 displayed by the display system 66.

Additionally or alternatively, in some embodiments, the display system 66 includes a projector, and the control system 76 is configured to adjust the appearance (e.g., angle, distortion, warping, projection mapping) of the virtual element(s) 64 based on a location of the projector with respect to the real element(s) 62 (e.g., a real wall). For instance, the projector may be configured to project the virtual element(s) 64 onto the real element(s) 62, and thus adjusting (e.g., via the control system 76) an angle, an appearance, a distortion, a warping, or any combination thereof, of the virtual element(s) 64 (e.g., image data) based on the location of the projector may provide a more realistic appearance of the reflected element(s) 74 that are based on a combination of both the virtual element(s) 64 and real element(s) 62 in the display area 60.

In addition, in some embodiments, the display area 60 may not be directly visible to the guest(s) 54 from the observation area 52. For instance, as further discussed herein, a partition (e.g., a wall, a panel, a screen) may be positioned to block the guest(s) 54 from directly seeing the display area 60 from the observation area 52. In an embodiment, the display area 60 may be elevated and positioned behind or over the observation area 52. Similarly, the display area 60 may be positioned underneath or in a recess relative to the observation area 52.

Continuing with FIG. 1, physical or real world element(s) positioned in the optical effect area 58 may include an interactive element(s) 68 (e.g., a performer, another guest, a prop, an object, an animated figure.) In addition, the optical effect system 56 may be configured to provide a visual illusion effect in which the interactive element(s) 68 appear as though they are interacting with (e.g., responding to, reacting to) and/or are residing in a same space as (e.g., co-located with) the real element(s) 62 and/or the virtual element(s) 64 of the display area 60. In addition, the reverse may be true in that the visual illusion effect may cause the real element(s) 62 and/or the virtual element(s) 64 of the display area 60 to appear as though they are interacting with and/or are co-located with the interactive element(s) 68 of the optical effect area 58.

To this end, the optical effect system 56 (e.g., the optical effect area 58) may include a beam splitter 70 (partially reflective surface) positioned to combine imagery from the optical effect area 58 with imagery from the display area 60. For example, from the observation area 52, the guest(s) 54 may view physical element(s) (e.g., including the interactive element 68, a physical object, a background scene, a performer, a prop, and/or a display) positioned within the optical effect area 58 as transmitted element(s) 72 that are transmitted or visible through the beam splitter 70. In other words, the guest(s) 54 may see through the beam splitter 70 and directly view the transmitted element(s) 72 that correlates to the physical element(s) positioned in the optical effect area 58. Moreover, the guest(s) 54 may view the real element(s) 62 and/or the virtual element(s) 64 of the display area 60 as reflected element(s) 74 that are reflected off the beam splitter 70 toward the observation area 52. That is, the guest(s) 54 may see a reflection of the real element(s) 62 and/or the virtual element(s) 64 via the beam splitter 68. In particular, lighting in the attraction system 50 (e.g., in the display area 60) may cause imagery of the real element(s) 62 and/or the virtual element(s) 64 of the display area 60 to be projected towards or onto the beam splitter 70 for reflection toward the observation area 52, and the beam splitter 70 may be oriented such that the reflected element(s) 74 (e.g., reflections of the real element(s) 62 and/or the virtual element(s) 64) may appear to be physically positioned in the optical effect area 58. In other words, the reflected element(s) 74 may appear to overlap (e.g., be combined with, overlay, be adjacent to) the transmitted element(s) 72.

By way of example, the beam splitter 70 may be angled (e.g., at approximately a 45 degree angle) with respect to a line of sight of the guest(s) 54 toward the optical effect area 58 and/or with respect to the projection of the real element(s) 62 and/or the virtual element(s) 64 from the display area 60 toward the beam splitter 70. Further, the beam splitter 70 may be made from a material, such as glass, plastic, a foil, and/or a semi-transparent mirror, that includes both transmissive and reflective properties to enable viewing of the transmitted element(s) 72 of the optical effect area 58 through the beam splitter 70 and viewing of the reflected element(s) 74 correlating to the real element(s) 62 and/or the virtual element(s) 64 of the display area 60 as reflected off the beam splitter 70.

The real element(s) 62 and/or the virtual element(s) 64 as illustrated within the reflected element(s) 74 in FIG. 1 are depicted with dashed lines to indicate that the real element(s) 62 and/or the virtual element(s) 64 of the display area 60 merely appear to be present in the optical effect area 58 while actually being a reflection of the real element(s) 62 and/or the virtual element(s) 64 with in the display area 60. The combined imagery of the transmitted element(s) 72 and the reflected element(s) 74 in the optical effect area 58 may provide a unique viewing experience for the guest(s) 54. For instance, movement, adjustment, or any other alteration of the real element(s) 62 and/or the virtual element(s) 64 in the display area 60 may cause corresponding change in the reflected element(s) 74 in the optical effect area 58.

As an example, the real element(s) 62 and/or the virtual element(s) 64 in the display area 60 may be adjusted (e.g., based on detected characteristics associated with the interactive element 68 and/or the optical effect area 58) to simulate an interaction between the transmitted element(s) 72 and the reflected element(s) 74 in the optical effect area 58. In addition, the real element(s) 62 and/or the virtual element(s) 64 may be adjusted to enable a more realistic appearance of the interaction and/or combination of the reflected element(s) 74 and the transmitted element(s) 72. Furthermore, in an embodiment, the reflected element(s) 74 viewable by the guest(s) 54 may also include certain properties, qualities, or characteristics (e.g., one or more visual characteristics.) In addition, the reflected element(s) 74 may have transparent or translucent properties. For example, the transmitted element(s) 72 and/or another physical element (e.g., the interactive element 74) in the optical effect area 58 may appear to be at least partially visible through the reflected element(s) 74. As such, an appearance of the reflected element(s) 74 may be different than that of a direct view of the real element(s) 62 and/or the virtual element(s) 64 within the display area 60.

Moreover, the optical effect system 56 may include a control system 76 (e.g., an automation controller, a programmable logic controller, an electronic controller) configured to operate to adjust the experience provided to the guest(s) 54 via the optical effect system 56. The control system 76 may include a memory 78 and a processing system 80 (e.g., a processor, processor system, processing circuitry, system of processors). The memory 78 may include volatile memory, such as random access memory (RAM), and/or non-volatile memory, such as read-only memory (ROM), optical drives, hard disc drives, solid-state drives, or any other non-transitory computer-readable medium that includes instructions. The processing system 80 may be configured to execute such instructions. For example, the processing system 80 may include one or more application specific integrated circuits (ASICs), one or more field programmable gate arrays (FPGAs), one or more general purpose processors, or any combination thereof. In certain instances, the control system 76 may include one or more controllers that are communicatively coupled and may individually or collectively perform actions described herein. Additionally or alternatively, the control system 76 may include one or more processing systems 80 and/or one or more memories 78 that may individually or collectively perform the actions described herein.

In some embodiments, the control system 76 may be communicatively coupled to components (e.g., the real element(s) 62 and/or display system 66) of the display area 60. For instance, the control system 76 may operate to provide the virtual element(s) 64 to the display system 66. By way of example, the control system 76 may transmit image data to the display system 66 to cause the display system 66 to display the virtual element(s) 64 based on the image data. Additionally or alternatively, the control system 76 may adjust and update the image data provided to the display system 66 to adjust the appearance of the virtual element(s) 64, which causes corresponding adjustment of an appearance of the reflected element(s) 74 in the optical effect area 58. In particular, the control system 76 may transmit image data to the display system 66 that results in perceived movement of the reflected element(s) 74 in the optical effect area 58, such as relative to the transmitted element(s) 72. As another example, the control system 76 may adjust and update the image data provided to the display system 66 based on detected position, outline, and/or movement of the interactive element 68. To this end, an appearance (e.g., position, outline, movement, color, shape) of the resulting reflected element(s) 74, such as the virtual element 64, may change based on the detected position, outline, and/or movement of the interactive elements 68.

The optical effect system 56 may include a sensor 82 communicatively coupled to the control system 76. In some embodiments, the sensor 82 may be disposed within and/or directed to the optical effect area 58. In addition, the sensor 82 may be configured to detect the interactive element 68, one or more properties (e.g., characteristics, visual characteristics) associated with interactive element 68, and/or one or more properties associated with the optical effect area 58, or any combination thereof, as sensor data. Furthermore, the sensor 82 is configured to send (e.g., transmit) the sensor data to the control system 76. For example, the sensor 82 may be a light sensor, an image sensor (e.g., a camera, 3-dimensional (3D) camera), a position sensor, a motion sensor, a depth sensor, or any combination thereof. In some embodiments, the sensor data may include information indicative of a detected position, outline, and/or movement of an element (e.g., object, guest, interactive element 68) within the optical effect area 58. For instance, the sensor 82 may detect (e.g., track) a position, outline, and/or movement of the interactive element(s) 68 within the optical effect area 58, and transmit the sensor data to the control system 76. The control system 76 may be configured to generate the image data based on the received sensor data. As a result, the virtual element(s) 64 displayed via the display system 66 and reflected via the beam splitter 70, has an increased realistic appearance as perceived by a point of view of the observation area 52. In particular, as discussed herein, the reflected virtual element(s) 64 are combined with (e.g., overlaying, superimposing, overlapping) the transmitted element(s) 72 via the beam splitter 70 as combined imagery when viewed by the guest 54.

Present embodiments provide for a dynamic optical effect system 56 that monitors the interactive element(s) 68 within the optical effect area 58 (e.g., primary stage of the Pepper's Ghost effect) to generate and/or adjust virtual element(s) 64 that correlate, correspond to, interact with, and/or are responsive to detected positioning and/or movement of the interactive element(s) 68. As such, when the virtual elements 64 are reflected via the beam splitter 70 and combined with the transmitted element(s) 72 within the optical effect area 58, the resulting combined imagery is a more realistic Pepper's Ghost illusion, which improves the immersive nature of the attraction and improves overall guest experience.

The optical effect system 56 may include a lighting system 84 (e.g., a lighting effect system, a projector system) communicatively coupled to and/or operated by the control system 76. In some embodiments, the light system 84 may include one or more light source(s) 86. The light source(s) 86 may include real light source(s), such that the light source(s) 86 may emit light. In some embodiments, the light source(s) 86 may include artificial light source(s) (e.g., virtual light source(s), digital light source(s), faux light source(s)), in that the light source(s) 86 may comprise an appearance of an object that may emit light, such as a lamp, lantern, flashlight, etc., and further be combined with virtual or digital light source(s). Specifically, the artificial light source(s) 86 may comprise an appearance of an object that may emit light or the artificial light source(s) 86 may emits a relatively small amount of light, and the optical effect system 56 may display a light beam (e.g., a virtual light source(s) via the display/projection system 66) that is then combined, via the beam splitter 70, with the artificial light source(s) 86 to appear as though the light beam is emitting from the artificial light source(s) 86. As another example, in some embodiments, the artificial light source(s) 86 may be entirely comprised of the virtual element(s) 64 displayed via the display/projection system 66 and combined with the transmitted element(s) 72 via the beam splitter 70.

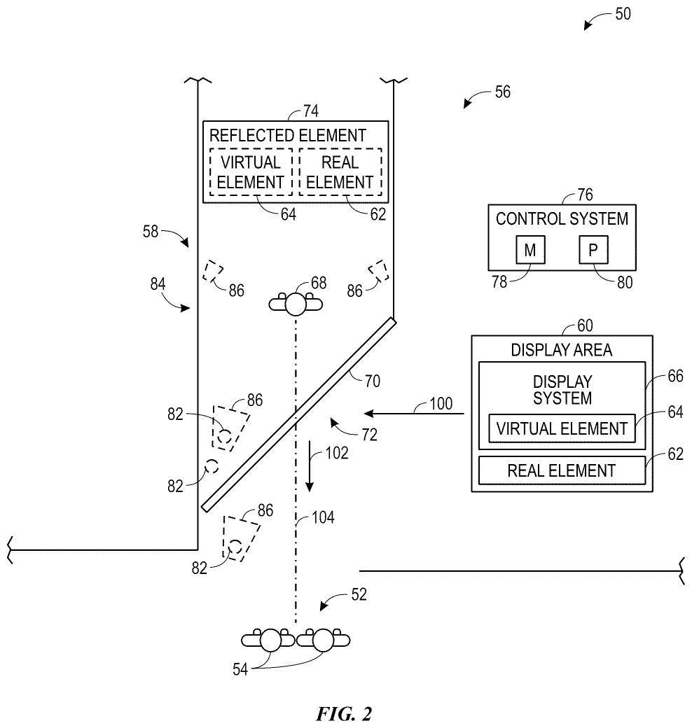

Furthermore, in some embodiments, the lighting system 84 may be communicatively coupled to and controllable via the control system 76. For example, the control system 76 may transmit instructions to the lighting system 84 to turn on and/or off a light emitted by the light source(s) 86, change a direction of the light emitted by the light source(s) 86, change a color, brightness, and/or appearance of the light emitted by the light source(s) 86, or any combination thereof. One or more of the light source(s) 86 may be positioned within the optical effect area 58 (e.g., behind the beam splitter 68 with respect to a point of view of the guests 54 within the observation area 52, as illustrated in FIG. 2). One or more of the light source(s) 86 may be positioned in proximity to the observation area 52 and directed towards the optical effect area 58 (e.g., in front of the beam splitter 68 with respect to a line of sight of the guests 54, as illustrated in FIG. 2). Moreover, in some embodiments, one or more of the light source(s) 86 may be static (e.g., remaining in a fixed position within the optical effect area 58). One or more of the light source(s) 86 may be dynamic, in that the light source(s) 86 may move throughout the optical effect area 58. Furthermore, one or more of the light source(s) 86 may be co-located with the sensor 82 or located separately from the sensor 82. In any case, the lighting system 84 may be configured to aid in presenting an illusion of emitting a light towards the optical effect area 58, such as a light that may cause shadows when the interactive element(s) 68 positioned within the optical effect area 58 is located in a pathway of the light.

In an embodiment, the display system 66 includes a projector configured to project a virtual shadow that corresponds with the interactive element 68 positioned within the optical effect area 58. As discussed herein, the sensor 82 detects characteristics, such as a position, an outline, movement, or any combination thereof, of the interactive element 68. In addition, the control system 76 may receive the detected position, outline, movement, or any combination thereof, of the interactive element 68 from the sensor 82 as sensor data. Furthermore, the control system 76 is configured to generate the virtual shadow based on the sensor data. The projector may be positioned within the display area 60 at a location that corresponds with a location of the sensor 82 directed towards the optical effect area 58. The virtual shadow, when displayed and reflected via the beam splitter 70 such that the virtual shadow is overlapping the interactive element 68, may appear (e.g., when viewed from the observation area 52) as a realistic shadow of the interactive element 68 within the optical effect area 58. From a perspective of the guest(s) 54, the virtual shadow may appear as though it is a real world shadow of the interactive element 68.

For example, the sensor 82 may be positioned at a distance from and/or at an angle with respect to a location (e.g., virtual location, perceived location from point of view of the guest 54 in the observation area 52) at which the reflected element(s) 74 may be visually present within the optical effect area 58. In the same way, the projector may be positioned at a distance from and/or at an angle with respect to a location of a projector screen on which the virtual shadow may be projected within the display area 60, and the distance and/or angle of the sensor 82 may be substantially the same as the distance and/or angle of the projector.

The lighting system 84 may also operate to provide dynamic stage lighting within the optical effect area 58 to improve a visual realism of the virtual shadow effect. For example, the control system 76 may cause (e.g., instruct, operate) the lighting system 84 to produce a light curtain effect, such that the interactive element 68 may be illuminated or not illuminated (e.g., darkened) based on a position and/or depth of the interactive element(s) 68 within the optical effect area 58 (e.g., located in the foreground versus the background of the optical effect area 58). The location of transition between the foreground and the background of the optical effect area 58 may correspond to a location of the reflected element(s) 74, such as the virtual wall and/or virtual shadow. As a result, the interactive element(s) 68 may be lit and thus more visible (e.g., to the guest(s) 54 in the observation area 52) when the interactive element(s) 68 is positioned in front of the location of the reflected element(s) 74 (e.g., the virtual wall and/or virtual shadow) with respect to the line of sight 104 of the guest(s) 54 within the observation area 52. In addition, the interactive element(s) 68 may not be lit and/or be darkened when the interactive element(s) 68 is positioned behind the location of the reflected element(s) 74 within the optical effect area 58. In this way, the virtual elements 64, such as the virtual shadow, reflected via the beam splitter 70 and combined with the transmitted element(s) 72 (e.g., the interactive element(s) 68) within the optical effect area 58, and the resulting combined imagery is a more realistic virtual shadow effect. In other words, as the interactive element(s) 68 approaches and passes through the location of the virtual wall and/or virtual shadow within the optical effect area 58, the guest(s) 54 within the observation area 52 may perceive the interactive element(s) 68 as passing through a physical wall within the optical effect area 58.

Continuing with the above example, the control system 76 may receive the sensor data from the sensor 82 and identify and/or isolate an outline (e.g., boundary, contour, silhouette, border) of the detected interactive element 68 within the optical effect area 58. In particular, the control system 76 may determine, from the sensor data, silhouette data that corresponds with the outline of the detected interactive element 68. In some embodiments, the control system 76 may additionally identify a position (e.g., location, depth) of the interactive element 68 relative to and/or within the optical effect area 58 based on the sensor data. Furthermore, the control system 76 may transmit image data (e.g., image data generated based on the sensor data provided by the sensor 82) to the display system 66 to generate the virtual element 64. For example, the control system 76 may utilize image analysis techniques (e.g., computer vision, image recognition) to determine (e.g., detect) one or more characteristics associated with the interactive element 68 (e.g., a size, a shape, a position, movement, an orientation, a type, or any combination thereof of the interactive element 68) within the optical effect area 58. In some embodiments, the control system 76 may additionally identify or determine a corresponding characteristic (e.g., visual characteristic, a size, a shape, a type, a position, movement, orientation) of image data to transmit to the display system 66 based on the determined one or more characteristics associated with the interactive element 68. For example, the control system 76 may identify an outline of the interactive element 68 and generate image data of a virtual shadow corresponding to the outline of the interactive element 68. The virtual shadow may include a dynamic darkened silhouette image of the interactive element 68 and may be a visual representation of the interactive element 68 that corresponds to the determined characteristics associated with the interactive element 68.

In addition, the control system 76 may determine a position of the interactive element 68 within the optical effect area 58 and generate image data with a corresponding position of the virtual shadow that, when the virtual shadow is combined with the interactive element 68 via the beam splitter 70, creates an illusion of a realistic shadow of the interactive element 68. In some embodiments, a portion of the virtual shadow may overlap and/or intersect with a portion of the interactive element 68. In particular, to generate a realistic shadow effect, the control system 76 may determine the position of the interactive element 68 and determine a corresponding projection position of the virtual element 64 to provide a desirable appearance of the reflected virtual element 64 in coordination with the interactive element 68. In some embodiments, the control system 76 may determine a position of the interactive element 68 based on a grid pattern of markers positioned within the optical effect area 58. In some embodiments, the sensor 82 may be a depth sensor, such as a LiDAR sensor and/or a near-infra red (NIR) sensor, that may detect positioning information of the interactive element 68 (e.g., location and/or depth of the interactive element 74) within the optical effect area 58.

The control system 76 may receive or determine a position of the light source(s) 86 with respect to the optical effect area 58. In particular, the control system 76 may receive or determine the position of the light source(s) 86 configured to create an illusion of virtual shadows of the interactive effect 68. The control system 76 may receive positional data of the light source(s) 86 that is stored in the memory 78. When fixed, the positional data of the light source(s) 86 within the optical effect system 56 and/or attraction system 50 may be known and stored in the memory 78. One or more of the light source(s) 86 may be dynamic light source(s) and the control system 76 may receive an indication of the positional data or the positional data of the light source(s) 86 from the light system 84 and/or light source(s) 86. The dynamic light source(s) 86 may include a location sensor configured to transmit positional information of the light source(s) 86 to the control system 76. The light source(s) 86 may include virtual light source(s), and as discussed in more detail below, the control system 76 may determine positional information of the virtual light source(s) based on a 3D scene rendered from and corresponding to the optical effect area 58.

Based on the received sensor data and/or positional data associated with the interactive element 68 and the positional data associate with the light source(s) 86, the control system 76 may determine the virtual element(s) 64 to be displayed via the display system 66. As discussed in more detail below, the control system 76 may generate image data including a virtual shadow to be displayed in the display area 60, and thus visualized via the reflected element(s) 74 within the optical effect area 58. The image data may include characteristics (e.g., distortion, angle, size, shape, outline, movement, position) of the virtual shadow that are based on the received sensor data and/or positional data associated with the interactive element(s) 68 and the positional data associated with the light source(s) 86. Furthermore, the control system may determine the characteristics of the virtual shadow within the image data based on comparing the sensor data and/or positional data associated with the interactive element(s) 68 with the positional data associated with the light source(s) 86. In particular, as a position of the interactive element(s) 68 changes in relation to a position of the light source(s) 86, the control system 76 may adjust the image data to generate the virtual shadow that comprises a position relative to the interactive element(s) (e.g., from the perspective of the observation area 52) a size, a shape, an angle (e.g., relative to the interactive element(s) 68), a distortion, or any combination thereof, that corresponds with characteristics and a position of the interactive element(s) 68 relative to a position of the light source 86. As an example, when the interactive element(s) 68 moves within the optical effect area 58 and increases a distance between the interactive element(s) 68 and the light source(s) 86, the control system 76 may adjust or update the image data such that the resulting displayed virtual shadow increases in size.

In this way, the present embodiments provide for a dynamic optical effect system 56 that monitors (e.g., tracks, via the sensor 82) the interactive element(s) 68 and the light source(s) 86 within the optical effect area 58 (e.g., primary stage of the Pepper's Ghost effect) to generate the virtual element(s) 64, such as virtual shadows, that correlate, correspond to, interact with, and/or are responsive to detected positioning and/or movement of the interactive element(s) 68 and/or the light source(s) 86. As such, when the virtual shadows are reflected via the beam splitter 70 and combined with the transmitted element(s) 72 within the optical effect area 58, the resulting combined imagery is a more realistic Pepper's Ghost illusion.

FIG. 2 is a schematic overhead view of an embodiment of the attraction system 50 of FIG. 1, in accordance with an aspect of the present disclosure. In particular, the attraction system 50 includes the observation area 52 with one or more guests 54 positioned therein and the optical effect system 56. The optical effect system 56 is configured to provide a virtual shadow effect, via a Pepper's Ghost illusion, that is viewable by the one or more guests 54 from the observation area 52. The optical effect system 56 may include the optical effect area 58 and the display area 60. The display area 60 includes the real element(s) 62, the display system 66 configured to display the virtual element(s) 64, or any combination thereof. The optical effect area 58 may include physical element(s), such as the interactive element 68, and be configured to provide a visual illusion effect in which the interactive element 68 appears as though it is interacting with and/or are residing in a same space as the real element(s) 62 and/or the virtual element(s) 64 of the display area 60. In addition, the reverse may be true in which the visual illusion effect may cause the real element(s) 62 and/or the virtual element(s) 64 of the display area 60 to appear as though they are interacting with and/or are co-located with the interactive element(s) 68 of the optical effect area 58. To this end, the optical effect system 56 (e.g., the optical effect area 58) may include the beam splitter or partially reflective surface 70 positioned to combine imagery from the optical effect area 58 with imagery from the display area 60.

From the observation area 52, the guest(s) 54 may view physical element(s), such as the interactive element(s) 68, positioned within the optical effect area 58 as the transmitted element(s) 72 that are transmitted or visible through the beam splitter 70. In other words, the guest(s) 54 may see through the beam splitter 70 and directly view the transmitted element(s) 72 that correlate to the physical element(s) positioned in the optical effect area 58. Moreover, the guest(s) 54 may view the real element(s) 62 and/or the virtual element(s) 64 of the display area 60 as reflected element(s) 74 that are reflected off the beam splitter 70 toward the observation area 52. That is, the guest(s) 54 may see a reflection of the real element(s) 62 and/or the virtual element(s) 64 via the beam splitter 70. In particular, lighting in the attraction system 50 (e.g., in the display area 60) may cause imagery of the real element(s) 62 and/or the virtual element(s) 64 of the display area 60 to be projected in a first direction 100 towards the beam splitter 70, reflected off (e.g., bounce off) of the beam splitter 70, and projected (e.g., as the reflected element(s) 74) in a second direction 102 toward the observation area 52. Furthermore, the beam splitter 70 may be oriented such that the reflected element(s) 74 (e.g., reflection of the real element(s) 62 and/or the virtual element(s) 64) appear to be physically positioned in the optical effect area 58. In other words, the reflected element(s) 74 may appear to overlap, interact with, and/or respond to a position, orientation, and/or movement of the transmitted element(s) 72.

As illustrated in FIG. 2, the beam splitter 70 may be angled (e.g., at approximately a 45 degree angle) with respect to a line of sight 104 of the guest(s) 54 toward the optical effect area 58 and/or with respect to the projection in the first direction 100 of the real element(s) 62 and/or the virtual element(s) 64 from the display area 60 toward the beam splitter 68. The real element(s) 62 and/or the virtual element(s) 64 within the reflected element(s) 74 in FIG. 2 are depicted with dashed lines to indicate that the real element(s) 62 and/or the virtual element(s) 64 of the display area 60 merely appear to be physically present in the optical effect area 58 while actually being a reflection of the real element(s) 62 and/or the virtual element(s) 64 with in the display area 60.

The optical effect system 56 of FIG. 2 is configured to present a virtual shadow effect that corresponds with the interactive element(s) 68 (e.g., another guest, an object) within the optical effect area 58. In other words, the guest(s) 54 within the observation area 52 viewing the optical effect area 58 may perceive what appears to be a realistic, physically present shadow of the interactive element(s) 68. In addition, in some embodiments, the optical effect system 56 may present an illusion in which the interactive element(s) 68 may appear (e.g., from the prospective of the guest(s) 54 in the observation area 52) to pass through (e.g., walk through, travel through) a wall within the optical effect area 58. In particular, the real element(s) 62 of the display area 60 may include a real-world wall and the virtual element(s) may include a virtual shadow that, as discussed herein, is generated and adjusted to correspond with the interactive element(s) 68. As such, the control system 76 may be configured to provide image data of the virtual shadow to be displayed and/or projected on the real-world wall. The imagery of the real-world wall and the virtual shadow may then be reflected via the beam splitter 70 towards the guest(s) 54 within the observation area 52. The reflection of the real-world wall and virtual shadow may appear as though they are actually present within the optical effect area 58.

The real-world wall may be relatively flat and/or may include portions with more complex geometry of projections, such as doors, windows, bricks, stone, and/or plants. The control system 76 may use projection mapping techniques to account for the more complex shapes and/or surfaces of the real-world wall. The display/projection system 66 may include multiple projectors positioned at various angles with respect to the real-world wall to cover the surfaces of the real-world wall with the projected image (e.g., the virtual shadow).

The control system 76 may be configured to provide image data of a virtual wall and a virtual shadow to the display system 66, and the virtual wall along with the virtual shadow may be displayed and/or projected via the display/projection system 66. The imagery of the virtual wall and virtual shadow may then be reflected and appear as though they are physically present within the optical effect area 58.

The control system 76 may adjust and/or update the image data provided to the display system 66 to adjust the appearance of the virtual wall and/or the virtual shadow, which causes corresponding adjustment of an appearance of the virtual wall and/or the virtual shadow as reflected via the beam splitter 70 towards the guest(s) 54 in the observation area 52. In other words, the virtual wall and/or virtual shadow may appear and/or be perceived to change, move and/or visually adjust in a realistic manner that may correspond to detected movement and/or positioning of the interactive element(s) 68, as discussed herein, within the optical effect area 58. As an example, the control system 76 may adjust and/or update the image data provided to the display system 66, and thus adjust the displayed and reflected virtual wall and/or virtual shadow, based on detected position, outline, and/or movement of the interactive element(s) 68. To this end, an appearance of the resulting reflected virtual wall and/or virtual shadow, may change based on the detected position, outline, and/or movement of the interactive element(s) 68.

The optical effect system 56 may include the sensor(s) 82 communicatively coupled to the control system 76 and configured to track and/or detect (e.g., measure) a position, outline, and/or movement of the interactive element(s) 68 within the optical effect area 58. The sensor(s) 82 may be positioned within and/or directed to the optical effect area 58. In addition, the sensor 82 may be configured to track and/or detect one or more properties associated with the interactive element(s) 68, one or more properties associated with the optical effect area 58, or any combination thereof, as sensor data. For example, the one or more properties may include a position, an outline, a texture, a shape, a size, a location, a depth, a movement, a color, identifying information, an orientation, or any combination thereof.

Furthermore, the sensor(s) 82 are configured to send (e.g., transmit) the sensor data to the control system 76. For example, the sensor(s) 82 may be a light sensor, an image sensor (e.g., a camera, 3-dimensional (3D) camera), a position sensor, a motion sensor, a depth sensor, a radio frequency (RF) sensor (e.g., near-field (NF) communication sensor), a global positioning systems (GPS) sensor, or any combination thereof. In some embodiments, the sensor data may include information indicative of a detected position, outline, and/or movement of the interactive element 68 within the optical effect area 58. For instance, the sensor 82 may detect and/or track a position, outline, and/or movement of the interactive element(s) 68, and transmit the sensor data to the control system 76. The control system 76 may receive the sensor data and be configured to generate the image data associated with the virtual wall and/or virtual shadow based on the received sensor data. More specifically, the control system 76 may use imaging techniques to detect an edge and/or outline of a shape of the interactive element 68 within the sensor data. In addition, the control system 76 may be configured to generate the image data that includes a portion of a resulting displayed image that is located inside of the detected edge that is darker (e.g., darker in color) than the remaining portions of the resulting displayed image. Thus, the resulting displayed image that is based on the image data may appear as though it is a shadow with a shape that corresponds with the shape of the interactive element 68. In addition, the edge of the outline may be adjusted or modified to correspond to a type of lighting within the optical effect area 58. For example, the control system 76 may generate image data of the virtual shadow in which the edges of the virtual shadow are fuzzy and/or crisp depending on the type of lighting and expected resulting shadow that would be cast. As a result, the virtual wall and/or virtual shadow displayed via the display system 66 and reflected via the beam splitter 70, create an increased realistic shadow effect in combination with the interactive element(s) 68 as perceived by a point of view of the guest(s) 54 within the observation area 52.

Throughout the remaining below discussion, the term virtual wall is used to include both embodiments of a reflected element 74 of a real-world wall that is located in the display area 60 and reflected via the beam splitter 70 and a reflected element 74 of an image of a wall displayed in the display area 60 (e.g., via the display system 66) and reflected via the beam splitter 70. In either embodiment, the reflected image of the wall appears to be physically present within the optical effect system 58, and thus will be referred to as a virtual wall.

Furthermore, as discussed herein, the reflected virtual wall and/or virtual shadow are combined with (e.g., overlaid with, superimposed with, overlapped with) the interactive element(s) 68 and/or other physical elements (e.g., transmitted element(s) 72) of the optical effect area 58 via the beam splitter 70 as combined imagery that is viewed by the guest 54 within the observation area 52. Thus, the present embodiments provide for a dynamic optical effect system 56 that monitors the interactive element(s) 68 within the optical effect area 58 to generate a realistic virtual wall and/or virtual shadow that correlates, corresponds to, interacts with, and/or is responsive to a positioning and/or movement of the interactive element(s) 68. As such, when the virtual wall and/or virtual shadow are reflected via the beam splitter 70 and combined with the interactive element(s) 68 within the optical effect area 58, the resulting combined imagery is a more realistic Pepper's Ghost illusion of the interactive element(s) 68 appearing to (e.g., from the perspective of the guest(s) 54 in the observation area 52) approach, pass through, or a combination thereof, a real-world wall that appears to be physically present within the optical effect area 58. In particular, in some embodiments, the virtual shadow may overlay and/or overlap the virtual wall in a visually realistic manner that mimics a real-world shadow cast from the interactive element(s) 68 on a real-world wall. In this way, the present virtual shadow effect provided by the optical effect system 56 improves the immersive nature of the attraction and improves overall guest experience within the attraction system 50.

Furthermore, the lighting system 84 may be communicatively coupled to and controllable via the control system 76. For example, the control system 76 may transmit instructions to the lighting system 84 to activate and/or deactivate a light emitted by the light source(s) 86, adjust a direction of the light emitted by the light source(s) 86, adjust a position of the light source(s) 86, change a color, brightness, and/or appearance of the light emitted by the light source(s) 86, or any combination thereof. As an example, a color of the virtual light source(s) may be adjusted to correspond with an expected color of light to be emitted by the artificial light source(s) 86. As illustrated in FIG. 2, one or more of the light source(s) 86 may be positioned within the optical effect area 58 (e.g., behind the beam splitter 70 with respect to the line of sight 104 of the guests 54 within the observation area 52). Alternatively, one or more of the light source(s) 86 may be positioned in proximity to the observation area 52 and directed towards the optical effect area 58 (e.g., in front of the beam splitter 70 with respect to a point of view of the guests 54, as illustrated in FIG. 2). One or more of the light source(s) 86 may be static, dynamic, co-located with the sensor 82, or located separately from the sensor 82. In any case, the lighting system 84 may be configured to aid in presenting an illusion of an emitted light (e.g., bright light) directed towards the optical effect area 58, such that the interactive element(s) 68 are located in a pathway of the emitted light may be expected to cast shadows. In particular, in some embodiments, the optical effect system 56 may produce an illusion of the interactive element(s) 68 being positioned between the light source(s) 86 and the virtual wall, such that the interactive element(s) 68 may be expected to cast shadows (e.g., virtual shadows) on the virtual wall.

The detected position of the interactive element(s) 68 in relation to the location or position of the reflected element(s) 74 (e.g., the virtual wall) from a perspective of the guests 54 may also be used to determine a period of time in which the virtual shadow is displayed. For example, as the interactive element(s) 68 passes through the virtual wall, the control system 76 may cause the display system 66 to stop displaying the virtual shadow on the virtual wall. Specifically, the optical effect system 56 may include a depth sensor (e.g., 3D camera) configured to detect a depth and/or position of the interactive element 68. Furthermore, the control system 76 may be configured to receive the 3D data, such as depth and/or position of the interactive element 68, and adjust the image data to not include the virtual shadow based on the depth and/or position. For example, a threshold depth and/or position may be determined based on the location or position of the reflected element(s) 74 (e.g., the virtual wall and/or virtual shadow) with in the optical effect area 58 as perceived by the point of view of the guests 54 with in the observation area 52. Moreover, the control system 76 may generate the image data to include the virtual shadow when the depth and/or position of the interactive element 68 is less than the threshold depth and/or position and adjust the image data to not include the virtual shadow when the depth and/or position of the interactive element 68 is greater than the threshold depth and/or position. In other words, when the interactive element(s) 68 passes through the virtual wall and appears to enter the background of the optical effect area 58, the guest 54 will not view the virtual shadow that corresponds with the interactive element(s) 68. In some embodiments, the location or position of the reflected element(s) 74 (e.g., perceived position of the reflected virtual wall within the optical effect area 58 as viewed by the guest 54) may be determined, via the control system 76, based on a three-dimensional (3D) digital rendering (e.g., a 3D digital representation) of the optical effect area 58, a position of the virtual wall as displayed in the display area 60 in relation to a position of the projector that displays the virtual wall, a position of the virtual wall as displayed in the display area 60 in relation to the beam splitter 70, or any combination thereof.

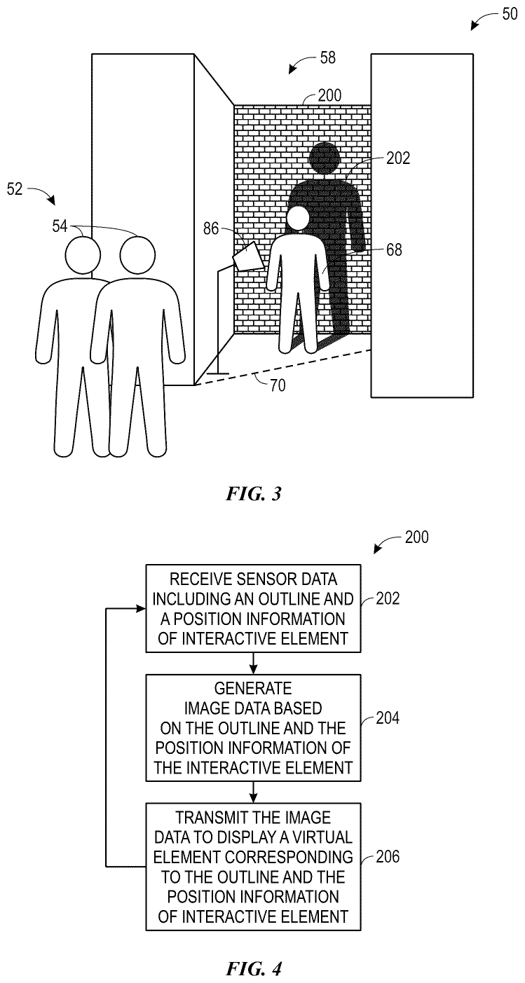

FIG. 3 is a perspective view of an embodiment of the attraction system 50 of FIG. 1, in accordance with an aspect of the present disclosure. In particular, FIG. 3 illustrates a view of the optical effect area 58 from a perspective of the guest(s) 54 within the observation area 52. The optical effect area 58 includes the interactive element(s) 68, a light source 86, as well as the virtual wall 200 and the virtual shadow 202 as the reflected element(s) 74. The virtual wall 200 and the virtual shadow 202 are reflected via the beam splitter 70 and appear as though they are physically present in the optical effect area 58. The image data of the virtual wall 202 may include any such texture and/or coloring to enhance the appearance and realism of the virtual wall 202. In addition, the image of the virtual shadow 202 includes an outline and/or edge (e.g., shape) that corresponds to an outline and/or edge (e.g., shape) of the interactive element(s) 68. The image of the virtual shadow 202 includes an interior of the outline that is darker in color and/or shade than an area outside of the outline.

A portion of the virtual shadow that overlaps with the interactive element(s) 68, from the perspective of the guest 54, may be excluded from the shadow such that the overlapping portion is not included in the outline or dark interior. In particular, the control system 76, via the sensor(s) 82, may detect a position, and a shape and/or outline of the interactive element(s) 68 within the optical effect area 58. In addition, as discussed herein, the control system 76 may generate image data of the virtual shadow that corresponds with the position and the shape and/or outline of the interactive element(s) 68. Furthermore, the control system 76 may additionally determine a portion, amount, and/or an area of the virtual shadow that may overlap the interactive element(s) 68 based on the detected position, and the shape and/or outline of the interactive element(s) 68 within the optical effect area 58 and a determined position, and the shape and/or outline of the resulting displayed virtual shadow within the optical effect area 58. In particular, the control system 76 may utilize a combination of 3D mapping techniques and shadow mapping techniques on image data of the optical effect area 58 to determine the overlapping portions. In response to determining the portion of the virtual shadow that may overlap with the interactive element(s) 68, the control system 76 may generate image data with a virtual shadow that excludes the overlapping portion from being part of the virtual shadow. In other words, when displayed, the virtual shadow includes the dark interior portion within the outline of the virtual shadow, except the overlapping portion. In this way, the control system 76 may display the virtual shadow in a manner that when viewed by the guests 54 appears as though the virtual shadow is behind the interactive element(s) 68 with respect to the point of view of the guests 54.

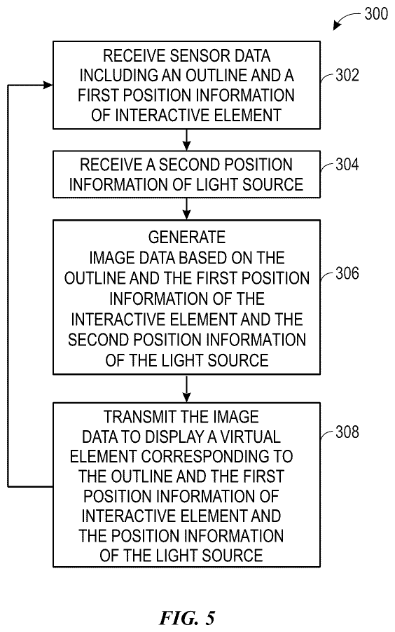

FIGS. 4 and 5 described below each illustrate a method or process for operation of the attraction system. Any suitable device (e.g., the processing system 80 of the control system 76 illustrated in FIGS. 1 and 2 in coordination with other system components) may perform the respective methods. In an embodiment, each method may be implemented by executing instructions stored in a tangible, non-transitory, computer-readable medium (e.g., the memory 78 of the control system 76). For example, each method may be performed at least in part by one or more software component(s), one or more software application(s), and the like. While each method is described using operations in a specific sequence, additional operations may be performed, the described operations may be performed in different sequences than the sequence illustrated, and/or certain described operations may be skipped or not performed altogether.

FIG. 4 is a flowchart of an embodiment of a method or process 200 for operating the attraction system 50 of FIG. 1 to provide a realistic virtual shadow effect via the Pepper's Ghost illusion, in accordance with an aspect of the present disclosure. That is, as discussed herein, the optical effect system 56 may be operated to provide a virtual image that includes a virtual shadow that may supplement the appearance of a real world object, such as the interactive element 68, as viewed by the guest(s) 54.

At block 202, the processing system may receive sensor data, via the sensor, that includes an outline and position information of the interactive element(s) in the optical effect area. For example, the sensor may include a camera configured to send image data of the optical effect area 58 as sensor data to the control system. The processing system may use imaging techniques to detect (e.g., identify, determine) an edge and/or an outline of a shape of the interactive element within the sensor data. In addition, the processing system may determine a position of the interactive element(s) within the optical effect area. For example, the sensor may include a depth sensor or 3D camera configured to determine positional information of the interactive element(s) and send the positional information to the control system as sensor data. In some embodiments, the optical effect system may include a tracking system, such as 3D camera(s), motion capture camera(s), and the like, configured to detect the position of the interactive element(s) within the optical effect area.

At block 204, the processing system may generate image data based on the outline and the position information of the interactive element. In particular, as discussed herein, the processing system may generate a shadow effect by configuring an interior of the determined outline to be darker in color than the remaining space around the outline. For example, the interior of the outline may be black in color, while the remaining space around the outline may be white in color. The characteristics of the generated image, such as size, shape, and position of the outline within the image data, may be based on characteristics from the received sensor data, such as a size, shape, and/or position of the outline. In other words, the characteristics of the generated image data including the virtual shadow may correlate to the characteristics of the outline and position information of the interactive element received via the sensor data.

At block 206, the processing system may transit the image data to display a virtual element corresponding to the outline and the position information of the interactive element. In particular, the processing system may transmit the image data to the display system. The display system may be configured to display the image data, on a display screen and/or via a projector, in the display area. The image data may then be projected towards the beam splitter to be reflected as the reflected element(s) and viewed by guest in the observation area. Specifically, as discussed herein, the reflected element(s) are combined with imagery of the optical effect area being transmitted (e.g., transmitted element(s)) through the beam splitter towards the guests. As a result, the combined imagery creates the virtual shadow effect in which the interactive element(s) appear to have a physical or real shadow cast onto the reflected element(s) and/or the transmitted element(s) that appears to be physically present within the optical effect area.

It should be noted that the method 200 may be continually or repeatedly performed. For example, the method 200 may continue through blocks 202-206 to provide real-time image data corresponding the interactive element(s) within the optical effect area. In this way, display of the virtual shadow effect, or virtual elements reflected via the beam splitter, may be continuously adjusted and/or updated to reflect any changes in position or movements of the interactive element(s). As such, the optical effect system may provide a more realistic virtual shadow effect that includes a virtual shadow that behaves as a real-world shadow that moves and/or changes with movement of the interactive element(s).

FIG. 5 is a flowchart of an embodiment of a method or process 300 for operating the attraction system 50 to provide a realistic virtual shadow effect via the Pepper's Ghost illusion, in accordance with an aspect of the present disclosure. That is, as discussed herein, the optical effect system 56 may be operated to provide a virtual image that includes a virtual shadow that may supplement the appearance of a real world object, such as the interactive element 68, as viewed by the guest(s) 54.

At block 302, the processing system may receive sensor data, via the sensor, that includes an outline and position information of the interactive element(s) in the optical effect area. For example, the sensor may include a camera configured to send image data of the optical effect area as sensor data to the control system. The processing system may use imaging techniques to detect an edge and/or an outline of a shape of the interactive element within the sensor data. In addition, the processing system may determine a position of the interactive element(s) within the optical effect area.

At block 304, the processing system may receive a position of the light source. In particular, the position of the light source may be known and stored via the memory of the control system. The processing system may retrieve the position of the light source from the memory. The position of the light source may be received via a sensor coupled to the light source. The sensor may include a camera configured to perform simultaneous localization and mapping (SLAM) tracking to calculate position and/or changes in position. While, in some embodiments, the optical effect system may include a tracking system, such as 3D camera(s), motion capture camera(s), and the like, configured to detect the position of the light source.

At block 306, the processing system may generate image data based on the outline and position information of the interactive element and the position of the light source. In particular, as discussed herein, the processing system may generate a shadow effect by configuring an interior of the determined outline to be darker in color than the remaining space around the outline. In addition, characteristics of the generated image, such as size, shape, and position of the outline within the image data, may be based on characteristics from the received sensor data, such as a size, shape, and/or position of the outline. In other words, the characteristics of the generated image data including the virtual shadow may correlate to the characteristics of the outline and position information of the interactive element received via the sensor data. In some embodiments, the processing system may determine a degree of warping of virtual shadow of the image data based on the position of the light source and the position of the interactive element(s). For example, the processing system may utilize or apply an image mapping technique(s) (e.g., image mapping techniques, forward mapping, backwards mapping) to the image data based on a spacial relationship between the position, orientation, and/or direction of the light source and the position of the interactive element(s) within the optical effect area. In this way, the processing system, via the image mapping techniques, account for a direction, a position, an angle, or any combination thereof of light emitted by the light source in relation to the position of the interactive element(s) within the optical effect area. As such, the generated image data includes a more realistic virtual shadow that corresponds to the position of the light source in relation to the position of the interactive element(s).

In some embodiments, the processing system may utilize 3D data and/or shadow mapping techniques to generate the image data including the virtual shadow. For example, the sensor may include a 3D depth camera and the processing system may receive 3D image data from the sensor. Furthermore, the processing system may generate (e.g., render) a 3D virtual/digital scene that corresponds with the optical effect area. In particular, the processing system (e.g., including a physics engine) may render physical elements located in the optical effect area, such as the interactive element(s), light source(s), walls, partitions, other physical objects, etc., as 3D elements within the 3D virtual/digital scene. The corresponding 3D elements may include 3D representations that correspond with the real-world physical elements, including the interactive element(s), of the optical effect area. In addition, via the virtual/digital 3D scene, the processing system may determine position information of the light source (e.g., whether a real-world light source or a virtual/digital light source), and position information of the interactive element(s) (e.g., and/or other objects within the virtual/digital 3D scene). The processing system may use shadow mapping techniques to determine a shadow map that corresponds with positions of the light source(s) and the interactive element(s) within the 3D scene. Further, the processing system may generate the image data including the virtual shadow based on the shadow map.

At block 308, the processing system may transit the image data to display a virtual element corresponding to the outline and the position information of the interactive element. In particular, the processing system may transmit the image data to the display system. In addition, as discussed herein, the display system may be configured to display the image data, on a display screen and/or via a projector, in the display area. The image data may then be projected towards the beam splitter to be reflected as the reflected element(s) and viewed by guest in the observation area. Specifically, as discussed herein, the reflected element(s) are combined with imagery of the optical effect area being transmitted (e.g., transmitted element(s)) through the beam splitter towards the guests. As a result, the combined imagery creates the virtual shadow effect in which the interactive element(s) appear to have a physical or real shadow cast onto the reflected element(s) and/or the transmitted element(s) that appears to be physically present within the optical effect area.

It should be noted that the method 300 may be continually or repeatedly performed. For example, the method 300 may continue through blocks 302-308 to provide real-time image data corresponding the interactive element(s) within the optical effect area. In this way, display of the virtual shadow effect, or virtual elements reflected via the beam splitter, may be continuously adjusted and/or updated to reflect any changes in position or movements of the interactive element(s). As such, the optical effect system may provide a more realistic virtual shadow effect that includes a virtual shadow that behaves as a real-world shadow that moves and/or changes with movement of the interactive element(s).

While only certain features have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more element(s) designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An optical effect system, comprising:
a sensor configured to capture sensor data from an optical effect area;
a display system configured to display an image based on the sensor data;
a beam splitter disposed between the optical effect area and an observation area such that the optical effect area is observable through the beam splitter from the observation area, wherein the beam splitter is positioned to reflect light from the image toward the observation area; and
a control system configured to:
determine a characteristic associated with a person or object in the optical effect area from the sensor data; and
determine the image based on the characteristic such that, when the image is displayed by the display system, the image is overlapping with the person or object when viewed from the observation area.

2. The optical effect system of claim 1, wherein the characteristic is associated with silhouette data corresponding to an outline of the person or the object in the optical effect area, and wherein the control system is configured to:
determine the image based on the silhouette data; and
cause display of the image via the display system, wherein the image includes a dynamic darkened silhouette image based on the silhouette data and is reflected from the beam splitter such that the dynamic darkened silhouette image is overlapping with the person or the object when viewed from the observation area.

3. The optical effect system of claim 2, wherein the control system is configured to present the dynamic darkened silhouette image as co-located with the person or the object in the optical effect area when viewed from the observation area.

4. The optical effect system of claim 2, wherein the control system is configured to detect a plurality of characteristics comprising the characteristic of the person or the object, and wherein the dynamic darkened silhouette image comprises a visual representation of the person or the object that corresponds to the plurality of detected characteristics, and wherein the plurality of detected characteristics comprises a size, a shape, the outline, a position, a movement, an orientation, a type, or any combination thereof.

5. The optical effect system of claim 2, wherein the dynamic darkened silhouette image is projected onto a physical wall, and wherein the dynamic darkened silhouette image and the physical wall are configured to be reflected by the beam splitter such that the dynamic darkened silhouette image and the physical wall are overlapping with the person or the object when viewed from the observation area.

6. The optical effect system of claim 2, comprising a lighting effect system configured keep a foreground of the optical effect area more lit than a background of the optical effect area, wherein the foreground is closer to the observation area than the background.

7. The optical effect system of claim 2, wherein the control system is configured to:
receive a location of the person or object in the optical effect area; and
cause display of the image to change such that the dynamic darkened silhouette image is not presented to the observation area based on a location of the person or the object in the optical effect area.

8. The optical effect system of claim 2, wherein the control system is configured to incorporate location data associated with the person or the object into the image based on measurements acquired by an optical sensor.

9. The optical effect system of claim 1, wherein the sensor is co-located with an object configured to emit light.

10. The optical effect system of claim 2, comprising a faux light source positioned in the optical effect area or in a location separate from the optical effect area by the beam splitter.

11. The optical effect system of claim 10, wherein the image comprises a light, and wherein the light is reflected from the beam splitter such that the light is presented as emitting from the faux light source and causing the dynamic darkened silhouette image associated with the person or the object when viewed from the observation area.

12. The optical effect system of claim 1, wherein the display system comprises:
a projector configured to project the image onto a surface angled toward the beam splitter, or
a backlit display configured to present the image, wherein the backlit display is angled toward the beam splitter.

13. The optical effect system of claim 1, comprising a control system configured to:
generate a three-dimensional (3D) rendering of the optical effect area;
determine a position of a person or an object within the 3D rendering; and
generate the image comprising a virtual shadow of the person or the object based on the determined position of the person or the object.

14. The optical effect system of claim 13, wherein the control system is configured to generate the image based at least on a determined shadow map of the 3D rendering associated with the position of the person or the object and a location of a digital light source.

15. A method of operating an optical effects system of an attraction system, the method comprising:
receiving, at a processing system, sensor data comprising one or more characteristics of a person or an object positioned within an optical effect area, wherein the sensor data is received from a sensor configured to monitor the optical effect area;
generating, at the processing system, image data based on the sensor data for a display system, wherein the image data comprises a virtual shadow with one or more visual characteristics that correspond to the one or more characteristics of the person or the object; and
instructing, via the processing system, display of the image data, wherein the image data is configured to be reflected and combined with imagery of the optical effect area via a beam splitter.

16. The method of claim 15, comprising:
receiving, at the processing system, first position information associated with the person or the object;
receiving, at the processing system, second position information of a light source associated with the optical effect area; and
generating, at the processing system, the image data based on an association of the first position information with the second position information.

17. The method of claim 16, wherein the light source comprises a digital light source and the sensor data comprises three-dimensional (3D) data associated with the optical effect area, and wherein the method comprises:
generating, at the processing system, a 3D digital representation of the optical effect area based on the 3D data;
determining, at the processing system, a shadow mapping of the optical effect area based on the first position information and the second position information; and
generating, at the processing system, the image data based on the shadow mapping.

18. The method of claim 16, wherein the light source is a real light source configured to emit a light towards the optical effect area; and wherein the method comprises generating, at the processing system, the image data by applying an image mapping technique based on a spacial relation between the first position information and the second position information.

19. The method of claim 15, comprising:
transmitting, via the processing system, instructions to the display system, wherein the instructions are configured to cause the display of the virtual shadow on a wall, and wherein the virtual shadow and the wall are configured to be reflected and combined with the imagery of the optical effect area via the beam splitter.

20. An attraction system of an amusement park, comprising:
an optical effect system comprising:
a primary stage configured to accommodate an interactive element;
a secondary stage configured to accommodate a display;
a sensor configured to detect one or more first characteristics associated with the interactive element; and
a control system comprising a processor system configured to:
receive sensor data from the sensor, wherein the sensor data comprises the one or more first characteristics;
generate image data comprising a virtual shadow, wherein the virtual shadow comprises a darkened silhouette of the interactive element with one or more second characteristics that correspond to the one or more first characteristics; and
cause display of the image data within the secondary stage; and
a beam splitter disposed between the primary stage and an observation area, wherein the beam splitter is configured to reflect the display of the image data towards the observation area, and wherein the observation area is positioned to enable a guest of the attraction system to view a combination of the reflected display of the image data and the interactive element.
